(19) United States
(12) Patent Application Publication
(10) Pub. No.: US 2016/0295058 A1
(43) Pub. Date: Oct. 6, 2016

(54) FLEXIBLE FLAT CABLE, IMAGE READING APPARATUS, AND IMAGE FORMING APPARATUS

(71) Applicant: FUJI XEROX CO., LTD., Tokyo (JP)

(72) Inventor: Toshio YOSHIHARA, Kanagawa (JP)

(73) Assignee: FUJI XEROX CO., LTD., Tokyo (JP)

(21) Appl. No.: 14/814,679

(22) Filed: Jul. 31, 2015

(30) Foreign Application Priority Data
Mar. 30, 2015 (JP) 2015-068013

(51) Int. Cl. H04N 1/00; H01R 12/77

(52) U.S. Cl. CPC H04N 1/00994; H01R 12/775; H04N 1/0083; H04N 1/00257; H04N 1/00278

(57) ABSTRACT

A flexible flat cable includes a first flat cable part having an electromagnetic shielding structure and flexibility, and a second flat cable part having an electromagnetic shielding structure and flexibility. The second flat cable part is different from the first flat cable part in at least one of electromagnetic shielding structure and flexibility.

### CROSS-REFERENCE TO RELATED APPLICATIONS

This application is based on and claims priority under 35 USC 119 from Japanese Patent Application No. 2015-068013 filed Mar. 30, 2015.

### BACKGROUND

### Technical Field

The present invention relates to a flexible flat cable, an image reading apparatus, and an image forming apparatus.

### SUMMARY

According to an aspect of the invention, there is provided a flexible flat cable including a first flat cable part having an electromagnetic shielding structure and flexibility, and a second flat cable part having an electromagnetic shielding structure and flexibility, wherein the second flat cable part is different from the first flat cable part in at least one of electromagnetic shielding structure and flexibility.

### BRIEF DESCRIPTION OF THE DRAWINGS

Exemplary embodiments of the present invention will be described in detail based on the following figures, wherein:

FIG. 1 illustrates the overall configuration of an image forming apparatus to which a flexible flat cable and an image reading apparatus are applied according to a first exemplary embodiment of the invention;

FIG. 2 illustrates the configuration of the image reading apparatus according to the first exemplary embodiment of the invention;

FIG. 3 is a perspective view illustrating the configuration of a part of the image reading apparatus according to the first exemplary embodiment of the invention;

FIG. 4 is a top view illustrating the configuration of the flexible flat cable;

FIG. 5A is a perspective view illustrating the configuration of the flexible flat cable;

FIG. 5B is a schematic cross-sectional view taken along line VB-VB of FIG. 5A;

FIG. 6A is a top view illustrating the configuration of the flexible flat cable;

FIG. 6B is a cross-sectional view illustrating the flexible flat cable;

FIGS. 7A and 7B are a top view and a back view illustrating a first flat cable part of the flexible flat cable;

FIGS. 8A and 8B are a top view and a back view illustrating a second flat cable part of the flexible flat cable;

FIG. 9 is an explanatory diagram illustrating an eye pattern of the flexible flat cable;

FIG. 10 is an explanatory diagram illustrating the transmission resistance of the flexible flat cable;

FIG. 11A is a graph illustrating an attenuation curve of a flexible flat cable having a length of 300 mm;

FIG. 11B is a graph illustrating an attenuation curve of a flexible flat cable having a length of 700 mm;

FIG. 12 illustrates the configuration of an image reading apparatus according to a second exemplary embodiment of the invention; and

FIG. 13 is a perspective view illustrating the configuration of a part of the image reading apparatus according to the second exemplary embodiment of the invention.

### DETAILED DESCRIPTION

Hereinafter, exemplary embodiments of the invention will be described with reference to the accompanying drawings.

### First Exemplary Embodiment

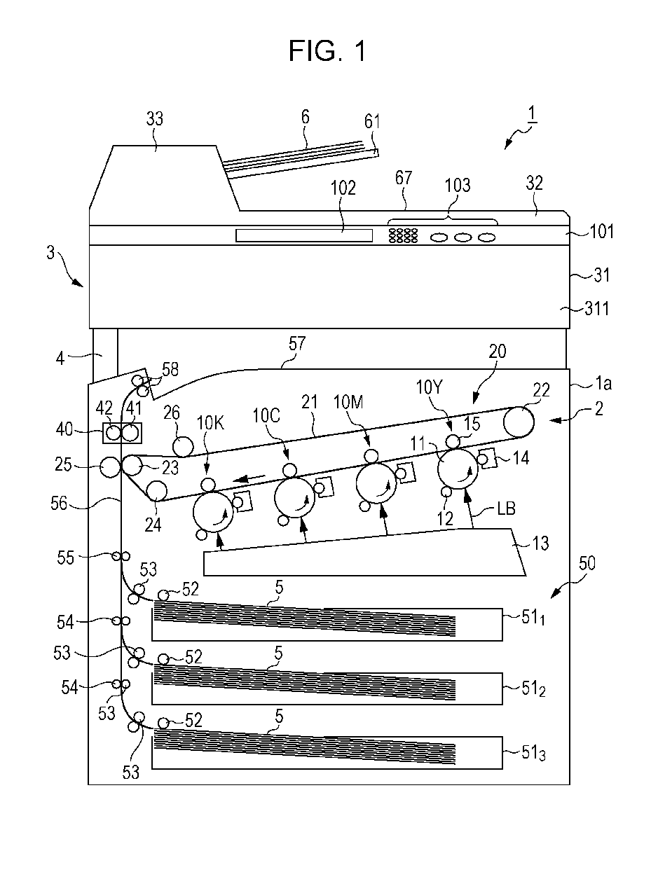

FIG. 1 illustrates the overall configuration of an image forming apparatus 1 to which a flexible flat cable 200 and an image reading apparatus 3 are applied according to a first exemplary embodiment of the invention.

Overall Configuration of Image Forming Apparatus

The image forming apparatus 1 according to the first exemplary embodiment may be a color copier, for example. The image forming apparatus 1 includes the image reading apparatus 3 that reads an image of a document 6, and an image forming section 2 as an example of an image forming unit that forms an image on a recording medium on the basis of image data. The image reading apparatus 3 is disposed over an apparatus body 1a accommodating the image forming section 2 and is supported by a support 4. A space into which a recording medium with an image formed thereon is ejected is formed between the image reading apparatus 3 and the apparatus body 1a.

Further, as illustrated in FIG. 1, in the image reading apparatus 3, a control panel 101 as an operation unit for operating the image forming apparatus 1 and the image reading apparatus 3 is disposed on the upper part of a front wall 311 located on a front face of a housing 31 of the image reading apparatus 3. The control panel 101 includes a touch panel 102 and plural operation buttons 103. The touch panel 102 receives various settings to the displayed operation menu, while serving also as a display unit that displays an operation menu, alerts, and messages for the user.

The image forming section 2 includes plural image forming devices 10, an intermediate transfer device 20, a paper feed device 50, and a fixing device 40. The image forming devices 10 form toner images developed with toner contained in developer. The intermediate transfer device 20 carries the toner images formed by the image forming devices 10, and finally transports the toner images to a second-transfer position where the toner images are second-transferred onto recording paper 5 as an example of a recording medium. The paper feed device 50 stores and transports required recording paper 5 to be supplied to the second-transfer position of the intermediate transfer device 20. The fixing device 40 fixes the toner images that are second-transferred on the recording paper 5 by the intermediate transfer device 20. The apparatus body 1a includes a support structure member, and an outer covering.

The image forming devices 10 include four image forming devices 10Y, 10M, 10C, and 10K dedicated to forming toner images of four colors of yellow (Y), magenta (M), cyan (C), and black (K). The four image forming devices 10 (Y, M, C, and K) are obliquely aligned in line in the internal space of the apparatus body 1a.

As illustrated in FIG. 1, each image forming device 10 (Y, M, C, K) has a rotatable photoconductor drum 11 as an example of an image carrier. Around the photoconductor drum 11, the following devices as an example of a toner image forming unit are arranged: a charging device 12, an exposure device 13, a developing device 14 (Y, M, C, K), a first-transfer device 15 (Y, M, C, K), and a drum cleaning device (not illustrated). The charging device 12 charges a peripheral surface (image carrying surface) of the photoconductor drum 11, on which an image may be formed, to a required potential. The exposure device 13 forms an electrostatic latent image having a potential difference (for the corresponding color) by radiating light based on image information (signals) onto the charged peripheral surface of the photoconductor drum 11. The developing device 14 forms a toner image by developing the electrostatic latent image with toner of developer of the corresponding color (Y, M, C, K). The first-transfer device 15 as an example of a first-transfer unit transfers the toner image onto the intermediate transfer device 20. The drum cleaning device removes attached substances, such as toner, remaining on and attached to the image carrying surface of the photoconductor drum 11 after first transfer.

The photoconductor drum 11 includes a cylindrical or column-shaped grounded base material, and an image carrying surface provided on a peripheral surface of the base material. The image carrying surface includes a photoconductive layer (photosensitive layer) formed of a photosensitive material. The photoconductor drum 11 is supported so as to be rotated in a direction of the arrow by power transmitted from a rotary driving device (not illustrated).

The charging device 12 includes a contact-type charging roller disposed in contact with the photoconductor drum 11. The charging device 12 is supplied with a charging voltage. In the case where the developing device 14 is one that performs reversal development, a voltage or current having the same polarity as the charging polarity of toner supplied from the developing device 14 is supplied as the charging voltage. Note that the charging device 12 may be a non-contact type charging device, such as a scorotron, that is disposed on the surface of the photoconductor drum 11 without contact therewith.

The exposure device 13 radiates light LB based on image information input to the image forming apparatus 1 onto the charged peripheral surface of the photoconductor drum 11 so as to form an electrostatic latent image. Upon forming a latent image, information (signals) on an image input to the image forming apparatus 1 by an arbitrary method is transmitted to the exposure device 13.

Each developing device 14 (Y, M, C, K) includes a housing having an opening and a reservoir for developer. Within the housing, a developing roller, first and second agitating and transport members (not illustrated) such as two screw augers, and a layer-thickness regulating member (not illustrated) are arranged. The developing roller carries and transports developer to a developing area opposed to the photoconductor drum 11. The first and second agitating and transport members agitate and transport the developer such that the developer passes along the developing roller. The layer-thickness regulating member regulates the amount (layer thickness) of developer to be carried on the developing roller. In the developing device 14, a developing voltage is supplied between the developing roller and the photoconductor drum 11 from a power supply device (not illustrated). The developing roller and the agitating and transport members are rotated in required directions by power transmitted from a rotary driving device (not illustrated). Further, as the developer of four colors (Y, M, C, and K), a two-component developer containing nonmagnetic toner and magnetic carrier is used.

Each first-transfer device 15 (Y, M, C, K) is a contact-type transfer device including a first-transfer roller that rotates in contact with the periphery of the photoconductor drum 11, with an intermediate transfer belt 21 interposed therebetween, and is supplied with a first-transfer voltage. As the first-transfer voltage, a direct-current voltage having a polarity opposite to the charging polarity of toner is supplied from the power supply device (not illustrated).

The drum cleaning device is disposed in contact with the peripheral surface of the photoconductor drum 11, and cleans off attached substances such as residual toner.

As illustrated in FIG. 1, the intermediate transfer device 20 is disposed over the image forming devices 10 (Y, M, C, and K). The intermediate transfer device 20 generally includes the intermediate transfer belt 21, plural belt support rollers 22 through 24, and 26, a second-transfer device 25, and a belt cleaning device (not illustrated). The intermediate transfer belt 21 rotates in a direction of the arrow while passing through first-transfer positions between the photoconductor drums 11 and the first-transfer devices 15 (first-transfer rollers). The belt support rollers 22 through 24, and 26 hold the intermediate transfer belt 21 from the inner side thereof in a desired state, and support the intermediate transfer belt 21 rotatably. The second-transfer device 25 as an example of a second-transfer member is disposed on an outer peripheral surface (image carrying surface) side of the intermediate transfer belt 21 supported by the belt support roller 23, and second-transfers the toner images on the intermediate transfer belt 21 onto recording paper 5. The belt cleaning device cleans off attached substances, such as toner and paper particles, remaining on and attached to the outer peripheral surface of the intermediate transfer belt 21 after the intermediate transfer belt 21 passes over the second-transfer device 25.

As the intermediate transfer belt 21, an endless belt is used that is formed of a material in which a resistance adjustment agent such as carbon black is dispersed in synthetic resin such as polyimide resin or polyamide resin, for example. The belt support roller 22 is a driving roller, and is rotationally driven by a driving device (not illustrated). The belt support roller 23 is a backup roller for second transfer. The belt support roller 24 is a tension applying roller that applies tension to the intermediate transfer belt 21. The belt support roller 26 is a driven roller that adjusts a running position of the intermediate transfer belt 21.

As illustrated in FIG. 1, the second-transfer device 25 is a contact-type transfer device including a second-transfer roller. The second-transfer roller rotates in contact with the peripheral surface of the intermediate transfer belt 21 at the second-transfer position in a portion of the outer peripheral surface of the intermediate transfer belt 21 supported by the belt support roller 23 in the intermediate transfer device 20. The second-transfer roller is supplied with a second-transfer voltage. Further, the second-transfer device 25 or the belt support roller 23 of the intermediate transfer device 20 is supplied with, as a second-transfer voltage, a direct-current voltage having an opposite polarity to or the same polarity as the charging polarity of toner.

The belt cleaning device is disposed in contact with the peripheral surface of the intermediate transfer belt 21 with a required pressure, and cleans off attached substances such as residual toner.

The fixing device 40 includes a drum-type or belt-type heating rotating body 41 that is heated by a heater such that the surface temperature is maintained at a predetermined temperature, and a drum-type or belt-type pressing rotating body 42 that rotates in contact with the heating rotating body 41 with a predetermined pressure substantially along an axial direction of the heating rotating body 41. In the fixing device 40, a contact portion where the heating rotating body 41 and the pressing rotating body 42 are in contact with each other serves as a fixing portion, where a required fixing operation (heating and pressing) is performed.

The paper feed device 50 is disposed under the image forming devices 10 (Y, M, C, and K) of yellow (Y), magenta (M), cyan (C), and black (K). The paper feed device 50 generally includes plural (or a single) paper containers 51₁ through 51₃ each storing sheets of recording paper 5 of the desired size and type in a stacked state, and delivery devices 52 and 53 that feed the sheets of recording paper 5 one by one from the paper containers 51₁ through 51₃. For example, the paper containers 51₁ through 51₃ are attached to be pulled out to a front side of the apparatus body 1a (the side surface that the user faces during operation).

Examples of the recording paper 5 include plain paper and OHP sheet that are used in electrophotographic copiers, printers and the like. In order to further improve the smoothness of the image surface after fixing, the surface of the recording paper 5 needs to be as smooth as possible. For example, coating paper obtained by coating the surface of plain paper with a resin or the like, and so-called heavy paper with a relatively high basis weight such as art paper for printing may also be used.

A paper feed and transport path 56 is provided between the paper feed device 50 and the second-transfer device 25. The paper feed and transport path 56 includes plural (or a single) paper transport roller pairs 54 and 55 that transport recording paper 5 fed from the paper feed device 50 to the second-transfer position. The paper transport roller pair 55 is a pair of rollers (registration rollers) that adjusts the transport time of the recording paper 5. Further, at a paper output port of the apparatus body 1a of the image forming apparatus 1, a paper output roller pair 58 is provided that outputs the recording paper 5, which is transported from the fixing device 40 after fixing, to a paper output part 57 disposed at the top of the apparatus body 1a.

Basic Operation of Image Forming Apparatus

Hereinafter, a basic image forming operation by the image forming apparatus 1 will be described.

Here, a description will be given of an image forming operation for forming a full-color image by combining toner images of four colors (Y, M, C, and K) using the above-described four image forming devices 10 (Y, M, C, and K).

When the image forming apparatus 1 receives command information of an image forming operation (printing) request, the four image forming devices 10 (Y, M, C, and K), the intermediate transfer device 20, the second-transfer device 25, the fixing device 40, and so on start.

In the image forming devices 10 (Y, M, C, and K), electrostatic latent images are visualized as toner images of four colors (Y, M, C, and K) developed with the corresponding color toners. When the color toner images formed by the image forming devices 10 (Y, M, C, and K) are transported to the first-transfer positions, the first-transfer devices 15 sequentially first-transfer and superpose the color toner images onto the intermediate transfer belt 21 rotating in the direction of the arrow in the intermediate transfer device 20. Subsequently, the intermediate transfer device 20 holds and transports the first-transferred toner images to the second-transfer position by rotating the intermediate transfer belt 21. Meanwhile, the paper feed device 50 feeds required recording paper 5 to the paper feed and transport path 56 in accordance with the image forming operation. In the paper feed and transport path 56, the paper transport roller pair 55 serving as a registration roller pair feeds and supplies the recording paper 5 to the second-transfer position in synchronization with the transfer time.

At the second-transfer position, the second-transfer device 25 second-transfers the toner images from the intermediate transfer belt 21 onto the recording paper 5 all at once. In the intermediate transfer device 20 after completion of the second transfer, the belt cleaning device (not illustrated) cleans off attached substances, such as toner, remaining on the surface of the intermediate transfer belt 21 from which the toner images are second-transferred.

Subsequently, the recording paper 5 with the toner images second-transferred thereon is separated from the intermediate transfer belt 21 and the second-transfer device 25, and is then transported to the fixing device 40. In the fixing device 40, the unfixed toner images are fixed on the recording paper 5 by a required fixing operation (heating and pressing). Finally, after completion of fixing, the recording paper 5 is output to, for example, the paper output part 57 disposed at the top of the apparatus body 1a by the paper output roller pair 58.

With the operation described above, the recording paper 5 on which a full-color image is formed by combining four color toner images is output.

Configuration of Image Reading Apparatus

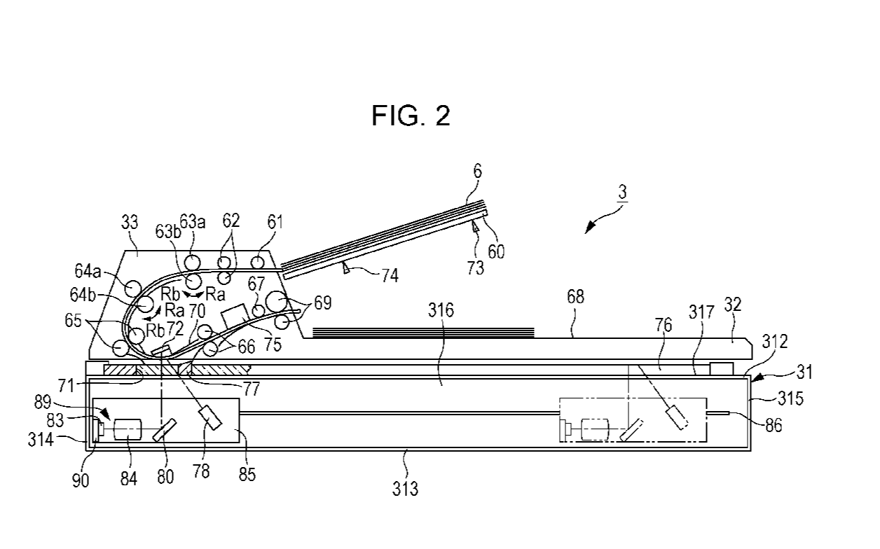

FIG. 2 is a schematic diagram illustrating the configuration of the image forming apparatus 3 to which the flexible flat cable 200 is applied according to the first exemplary embodiment.

The image reading apparatus 3 generally includes the housing 31 having a top surface on which a document reading surface is formed, a document pressing cover 32 openably and closably attached to the housing 31, and a Duplex Automatic Document Feeder (DADF) 33 provided at an end of the document pressing cover 32.

The image reading apparatus 3 is switchable between a first reading mode and a second reading mode. In the first reading mode, documents 6 are read while being automatically transported one by one by the Duplex Automatic Document Feeder (DADF) 33. In the second reading mode, a document 6 placed on a document table 76 (described below) is read. The solid lines in FIG. 2 indicate the state of the components upon reading a document in the first reading mode.

The Duplex Automatic Document Feeder 33 includes a document transport mechanism. The document transport mechanism includes a document tray 60 that stores documents 6 in a stacked state, a delivery roller 61 that feeds the documents 6 from the document tray 60, separation rollers 62 that separates the documents 6 fed by the delivery roller 61 from one another, transport rollers 63 through 67 that transport the document 6 to a document reading position, and output rollers 69 that output the document 6 to an output tray 68. The delivery roller 61, the separation rollers 62, the transport rollers 63 through 67, and the output rollers 69 are driven by a driving unit (not illustrated) upon reading the document 6. The transport rollers 64 serve as registration rollers. The transport rollers 63 disposed upstream of the transport rollers 64 in the transport direction serve as pre-registration rollers. The transport roller 67 is a roller that presses the upper surface (back surface) of the document 6.

The transport rollers 63 and the transport rollers 64 disposed in the transport direction of the document 6 serve as a correcting unit that mechanically corrects an inclination of the document 6 with respect to the transport direction. As illustrated in FIG. 2, of the transport rollers 63 disposed upstream in the transport direction of the document 6, a transport roller 63b as a driving roller is rotatable by a driving unit such as a drive motor (not illustrated) in a normal rotation direction Ra and a reverse rotation direction Rb of FIG. 2. A transport roller 63a as a driven roller rotates in pressure contact with the transport roller 63b in accordance with the rotation of the transport roller 63b. The rotation direction of the transport roller 63b is opposite to the rotation direction of the transport roller 63a.

Similarly, of the transport rollers 64 disposed downstream in the transport direction of the document 6, a transport roller 64b as a driving roller is rotatable by a driving unit such as a drive motor (not illustrated) in a normal rotation direction Ra and a reverse rotation direction Rb of FIG. 2. A transport roller 64a as a driven roller rotates in pressure contact with the transport roller 64b in accordance with the rotation of the transport roller 64b. The rotation direction of the transport roller 64b is opposite to the rotation direction of the transport roller 64a.

The transport rollers 63 form a mechanical skew correcting unit that causes the leading edge of the document 6 to hit the stopped transport rollers 64 disposed downstream thereof so as to bend the document 6, and thereby performs an inclination correction (hereinafter referred to as “skew correction”) of the transported document 6 with respect to the transport direction. Similarly, the transport rollers 64 also form a mechanical skew correcting unit that causes the leading edge of the document 6 to hit the stopped transport rollers 65 disposed downstream thereof so as to bend the document 6, and thereby performs a skew correction of the transported document 6 with respect to the transport direction. The transport rollers 63 and 64 are controlled by a controller, and perform a mechanical skew correction only when needed. Accordingly, the transport rollers 63 and 64 are usually rotated in the normal rotation direction Ra. Note that the skew of the document 6 does not have to be corrected in two steps using both the transport rollers 63 and the transport rollers 64, and a skew correction of the document 6 may be performed using only the transport rollers 63 or the transport rollers 64.

Further, the Duplex Automatic Document Feeder 33 includes a curved reading guide 70 that guides the document 6 to the reading position and further guides the document 6 from the reading position to the output direction, a plate-shaped specular reflection board 72 disposed on the reading guide 70 over a read window 71, a first size detection sensor 73 that detects the size of the document 6 in a sub scanning direction, a second size detection sensor 74 that also detects the size of the document 6 in the sub scanning direction, and a back surface reading unit 75 that reads an image on the back surface of the document 6 when needed.

The housing 31 of the image reading apparatus 3 is formed as a cuboid box in which a part of the top surface is opened. The housing 31 includes an upper wall 312 facing the document pressing cover 32, a bottom wall 313 facing the upper wall 312, side walls 314 and 315 facing each other in the sub scanning direction (the lateral direction in FIG. 2) with the bottom wall 313 interposed therebetween, the above-described front wall 311 (see FIG. 1), and a rear wall 316 facing the front wall 311 in a main scanning direction (the direction orthogonal to the plane of FIG. 2).

An opening 317 is formed at a portion of the upper wall 312 of the housing 31 corresponding to the document reading position of the document 6 to be read in the second reading mode. The transparent document table 76 (platen glass) that supports the document 6 is disposed at the opening 317. Further, the transparent read window 71 for reading the document 6 in the first reading mode is provided at the Duplex Automatic Document Feeder 33 side of the document table 76. A guide member 77 that guides the document 6 in the first reading mode is provided between the read window 71 and the document table 76.

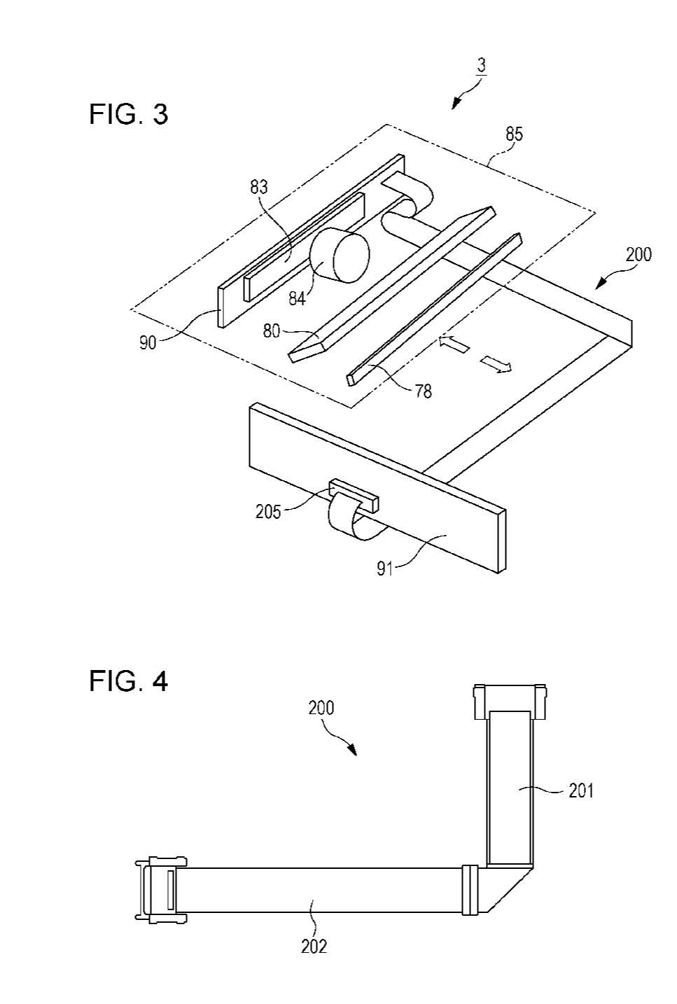

As illustrated in FIGS. 2 and 3, the image reading apparatus 3 includes, in the housing 31, a light source 78 including a light emitting diode (LED) and an illuminating lamp that illuminates the document 6, a mirror 80 that receives light reflected from the document 6, and an image reading section 89. The image reading section 89 includes an imaging lens 84 that forms an image of the light reflected from the mirror 80 on an image forming element 83 including a Charge Coupled Device (CCD), the image forming element 83 that reads an image of the document 6, and a first circuit board 90 with the image reading element 83 mounted thereon. The light source 78, the mirror 80, the image reading element 83, and the first circuit board 90 are disposed in the main scanning direction.

The light source 78, the mirror 80, the imaging lens 84, the image reading element 83, and the first circuit board 90 are fixed to a moving body 85 that includes a carriage and that is movable in the sub scanning direction. The moving body 85 is movable in the sub scanning direction at a required moving speed on rails 86 disposed on the rear wall 316 and the front wall 311 of the housing 31 in the sub scanning direction.

In the first reading mode, as indicated by the solid lines in FIG. 2, the moving body 85 is stopped at the reading position provided at the left end of the housing 31. Thus, the Duplex Automatic Document Feeder 33 automatically transports the document 6, and the light source 78 illuminates the document 6 passing over the read window 71. The light reflected from the document 6 is reflected by the mirror 80 toward the imaging lens 84. The image reading section 89 forms an image of the light reflected from the mirror 80 on the image reading element 83 including a CCD via the imaging lens 84, reads the image of the document 6 using the image reading element 83, and outputs image data.

On the other hand, in the second reading mode, the document 6 is placed on the document table 76 with the image surface down, and the document 6 placed on the document table 76 is pressed by the document pressing cover 32. While the moving body 85 moves in the sub scanning direction by being guided by the rails 86 disposed on the rear wall 316 and the front wall 311 of the housing 31 in the sub scanning direction, the light source 78 illuminates an area of the document 6 to be read, and the light reflected from the document 6 is reflected by the mirror 80 toward the imaging lens 84. Further, the image reading section 89 disposed in the moving body 85 forms an image of the light reflected from the mirror 80 on the image reading element 83 including a CCD via the imaging lens 84, reads the image of the document 6 using the image reading element 83, and outputs image data.

Configuration of Part of Image Reading Apparatus

As illustrated in FIG. 3, the image reading apparatus 3 according to the first exemplary embodiment includes the flexible flat cable (FFC) 200 according to the first exemplary embodiment which connects the first circuit board 90 with the image reading element 83 mounted thereon and a control board 91 as an example of a second circuit board to each other. The control board 91 is provided in the housing 31 of the image reading apparatus 3 or the apparatus body 1a of the image forming apparatus 1.

The image reading element 83 photoelectrically converts an optical image of the document 6 formed on a light receiving surface. The first circuit board 90 with the image reading element 83 mounted thereon generates and outputs read data as an analog or digital electric signal on the basis of a signal output from the image reading element 83. Further, the control board 91 has a function that converts the read data output from the first circuit board 90 into a digital electric signal when needed, and generates and outputs image data obtained by performing predetermined image processing on the read data of the digital signal. The image processing performed by the control board 91 is processing in which parameters and processing methods used in the image processing are determined in advance in accordance with the document size of the document 6. Examples of the image processing include shading correction processing and scaling processing. Further, the control board 91 has a function of an output interface that outputs image data on which image processing is performed.

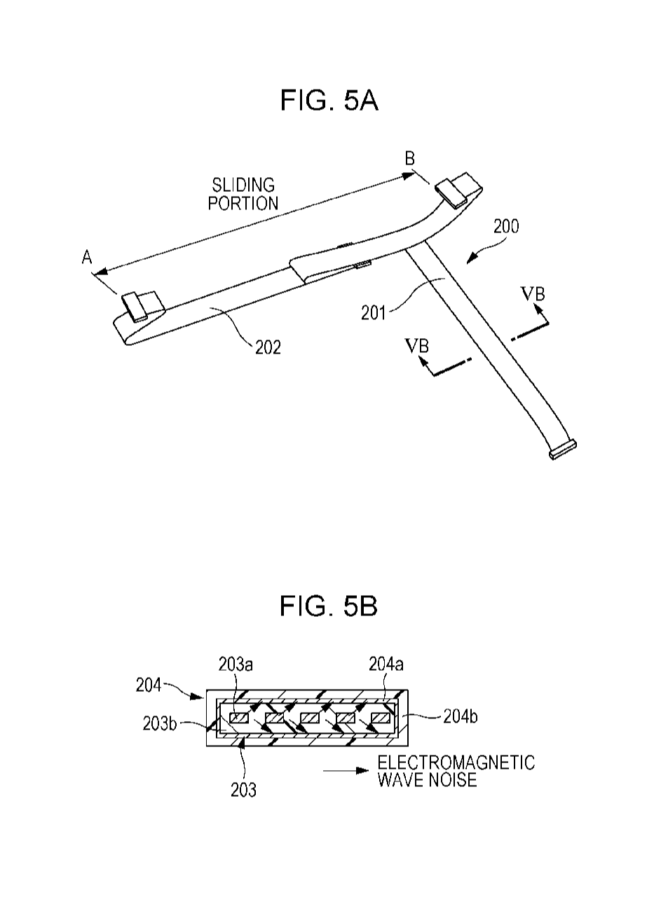

As illustrated in FIGS. 3 and 4, the flexible flat cable 200 includes a first flat cable part 201 disposed at the control board 91 side and a second flat cable part 202 disposed at the first circuit board 90 side. The first flat cable part 201 is disposed and fixed at the control board 91 side. On the other hand, as illustrated in FIGS. 3 and 5A, the second flat cable part 202 is disposed at a sliding portion so as to move from a point A to a point B in a bent state in accordance with movement of the moving body 85 in the sub scanning direction. Although each of the first and second flat cable parts 201 and 202 has an electromagnetic shielding structure and flexibility, the first flat cable part 201 and the second flat cable part 202 are different from each other in at least one of electromagnetic shielding structure and flexibility.

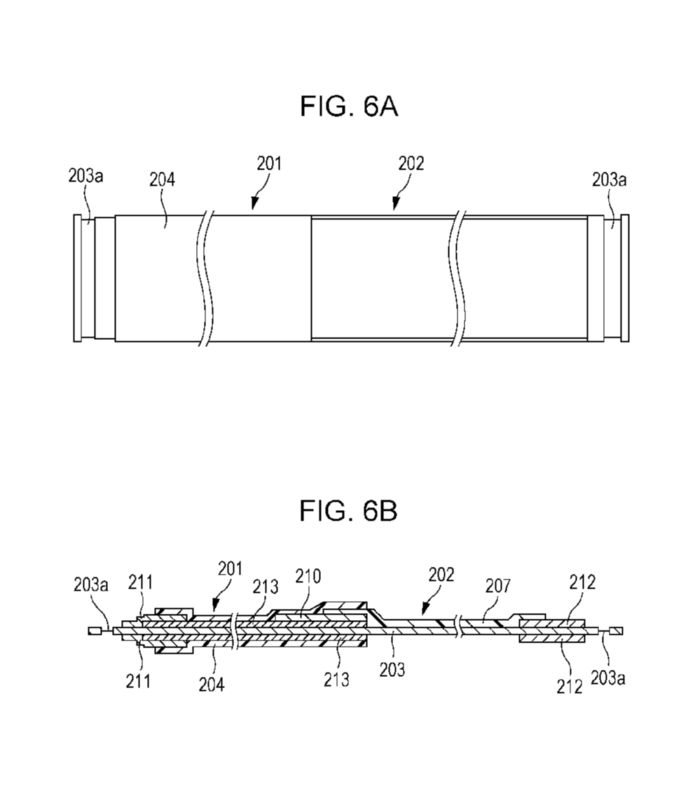

As illustrated in FIG. 6B, the flexible flat cable 200 includes a flat cable body 203 common to the first and second flat cable parts 201 and 202. As schematically illustrated in FIG. 5B, the flat cable body 203 includes plural (for example, 50) flat conductors 203a that are arranged in parallel to each other at required intervals, and an insulating film 203b which is made of a synthetic resin and in which an adhesive layer that covers the opposite surfaces of the plural conductors 203a throughout the entire length thereof. The flat conductors 203a are made of a soft copper foil formed by annealing hard copper. Further, the insulating film 203b is made of a synthetic resin film such as polyethylene terephthalate and polyethylene naphthalate. As illustrated in FIGS. 6A and 6B, the conductors 203a are exposed at both ends of the flat cable body 203. The exposed portions of the conductors 203a are gold plated or tin-plated so as to reduce electric contact resistance.

The flat cable body 203 is set such that the conductor 203a has, for example, a thickness of 0.035 mm, a width of 0.32 mm, and a pitch of 0.5 mm. The flat cable body 203 is used in various transmission systems. For example, in the case of low voltage differential signaling (LVDS) system, the characteristic impedance is set to 100Ω at a transmission rate of 280 M through 2 Gbps in a differential mode. In the case of a transmission system using V-by-One, the flat cable body 203 is used at a transmission rate of 3.75 Gbps.

As illustrated in FIG. 5B, in the case of transmitting a high-frequency signal though the flexible flat cable 200, there is a problem of electromagnetic interference in which high-frequency electromagnetic wave noise radiated from the conductors 203a of the flexible flat cable 200 affects surrounding electronic devices.

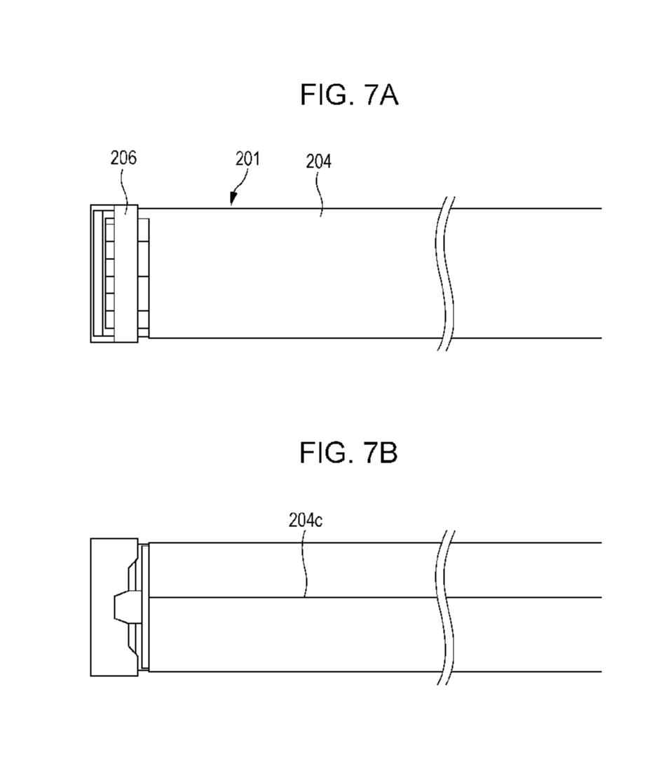

The flexible flat cable 200 according to the first exemplary embodiment has an electromagnetic shielding structure that reduces electromagnetic interference (EMI) radiated from the flat cable body 203. As illustrated in FIGS. 6A through 7A, the first flat cable part 201 of the flexible flat cable 200 includes a first shield layer 204 that covers the entire periphery including the front and back surfaces and the opposite side surfaces of the flat cable body 203. The first shield layer 204 includes a metal layer 204a and an insulating film 204b. The metal layer 204a is made of aluminum (Al), copper (Cu), silver (Ag), or the like, and is vapor deposited on the inner surface of the insulating film 204b. An adhesive layer is formed on the inner surface of the metal layer 204a. The insulating film 204b is made of a synthetic resin such as polyethylene terephthalate and polyethylene naphthalate. The first shield layer 204 is provided so as to surround the entire periphery of the flat cable body 203, with the metal layer 204a inside. Note that as the first shield layer 204, a film made of a synthetic resin, such as polyethylene terephthalate and polyethylene naphthalate, to which a metal foil made of aluminum or the like is attached by bonding or the like may be used. In FIG. 7B, the reference numeral 204c denotes a mating face of the first shield layer 204.

The first shield layer 204 has flexibility because the base material is made of a synthetic resin such as flexible polyethylene terephthalate and polyethylene naphthalate, and because the metal layer 204a made of aluminum or the like and serving as a shield is formed by vapor deposition. Accordingly, the first flat cable part 201 may be bent freely upon connecting to the control board 91. Further, a plug 206 to be connected to a socket 205 of the control board 91 is attached to an end of the first flat cable part 201.

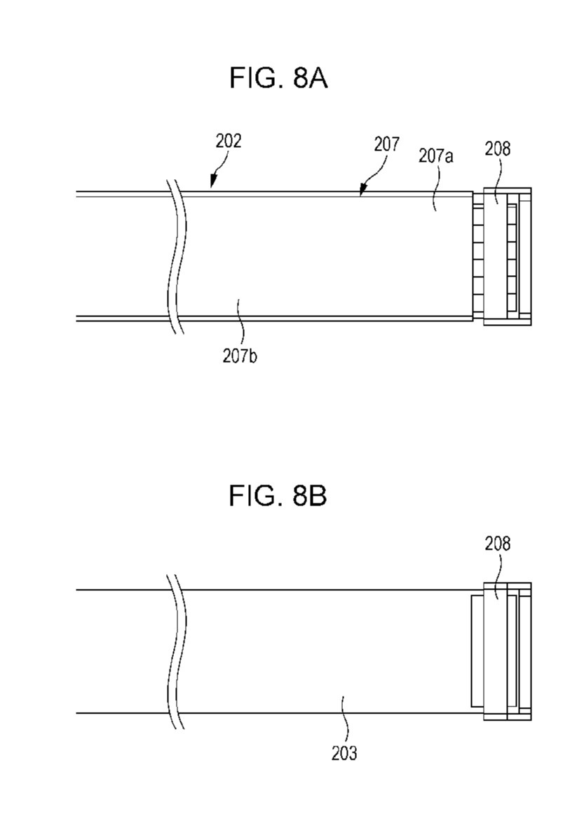

On the other hand, as illustrated in FIGS. 6B and 8A, the second flat cable part 202 of the flexible flat cable 200 includes a second shield layer 207 that covers either one of the front surface and the back surface of the flat cable body 203. The second shield layer 207 includes an insulating film 207b with a metal layer (foil) 207a formed thereon. The metal layer 207a is made of copper (Cu), aluminum (Al), silver (Ag), or the like and is formed in a lattice (mesh) pattern by vapor deposition or printing. The insulating film 207b is made of a synthetic resin such as polyethylene terephthalate and polyethylene naphthalate. The lattice size of the metal layer (foil) 207a of the second shield layer 207 is set to a value that is considerably less than the wavelength of a high-frequency signal passing through the flat cable body 203. Note that as the second shield layer 207, a film made of a synthetic resin, such as polyethylene terephthalate and polyethylene naphthalate, to which a metal foil made of copper (Cu), aluminum (Al), or the like is attached by bonding or the like may be used.

The second shield layer 207 has a higher flexibility than the first shield layer 204 because the base material is the insulating film 207b made of a synthetic resin such as flexible polyethylene terephthalate and polyethylene naphthalate, and because the metal layer 207a made of copper or the like and serving as a shield is formed in a lattice pattern. Accordingly, the second flat cable part 202 exhibits excellent flexibility and high bending performance when the sliding portion moves in the sub scanning direction in accordance with the reciprocating movement of the moving body 85 in the sub scanning direction. Further, a plug 208 to be connected to a socket (not illustrated) of the first circuit board 90 is attached to an end of the second flat cable part 202.

On the other hand, in the first shield layer 204, the entire periphery including the front and back surfaces and the opposite side surfaces of the flat cable body 203 is covered with the insulating film 204b which is made of a synthetic resin and on which the metal layer 204a made of aluminum or the like is vapor deposited. Thus, the first shield layer 204 has a higher electromagnetic shielding performance than the second shield layer 207 including the insulating film 207b which covers the front surface or the back surface of the flat cable body 203 and on which the metal layer 207a made of copper or the like is formed in a lattice (mesh) pattern.

Further, in the flexible flat cable 200, the first shield layer 204 of the first flat cable part 201 and the second shield layer 207 of the second flat cable part 202 are connected to each other in the following manner. As illustrated in FIG. 6B, at another end of the first flat cable part 201, a connection plate (ground plate) 210 is stacked on the surface of the flat cable body 203. The connection plate 210 electrically connects the metal layer 204a of the first shield layer 204 to the metal layer 207a of the second shield layer 207. The second shield layer 207 extends so as to cover the surface of the connection plate 210 stacked on the first flat cable part 201 at the second flat cable part 202 side. Further, the first shield layer 204 is disposed so as to cover the surface of the connection plate 210 at the first flat cable part 201 side and the surface of the second shield layer 207. Accordingly, the metal layer 204a of the first shield layer 204 and the metal layer 207a of the second shield layer 207 are electrically connected to each other with the connection plate 210. Note that the adhesive layers disposed on the metal layer 204a of the first shield layer 204 and the metal layer 207a of the second shield layer 207 are partially removed such that exposed portions of the metal layer 204a of the first shield layer 204 and the metal layer 207a of the second shield layer 207 are connected to the connection plate 210.

Further, at the end of the first flat cable part 201, a connection plate (ground plate) 211 is disposed so as to cover both the front and back surfaces of the flat cable body 203 and an adjustment layer 213. The connection plate 211 connects the first shield layer 204 to an earth potential. Further, at the end of the second flat cable part 202, both the front and back surfaces of the flat cable body 203 are covered with a connection plate (ground plate) 212 that connects the second shield layer 207 to an earth potential. Note that in the first flat cable part 201, both the front and back surfaces of the flat cable body 203 are covered with the adjustment layer 213 that adjusts the dielectric constant.

Configuration of Part of Image Reading Apparatus

In the image forming apparatus 3 according to the first exemplary embodiment, image data of the document 6 read by the image reading element 83 is output to the control board 91 from the first circuit board 90 through the flexible flat cable (FFC) 200 in the following manner.

In the image reading apparatus 3, as illustrated in FIG. 2, upon reading the image of the document 6 in the second reading mode, the image of the document 6 placed on the document table 76 is illuminated by the light source 78 mounted on the moving body 85. Thus, an image of reflected light from the document 6 is reflected by the mirror 80, and is scanned and exposed on the image reading element 83 via the imaging lens 84. In this step, the moving body 85 is driven by a driving unit (not illustrated) in the sub scanning direction so as to scan the entire surface of the document 6 placed on the document table 76.

The image of the document 6 read by the image reading element 83 is converted into an analog signal, and then is output from the first circuit board 90 to the control board 91 through the flexible flat cable 200. In the control board 91, required image processing such as shading correction is performed by an image processing circuit.

In this step, as illustrated in FIG. 5A, in the second flat cable part 202 of the flexible flat cable 200, the sliding portion where the second flat cable part 202 is bent moves in the sub scanning direction in accordance with the reciprocating movement of the moving body 85.

Since only either surface of the flat cable body 203 is covered with the second shield layer 207, the second flat cable part 202 of the flexible flat cable 200 has a higher flexibility than the first flat cable part 201. Accordingly, even in the case where the second flat cable part 202 is repeatedly deformed due to the reciprocating movement of the moving body 85, it is possible to prevent a large bending stress or the like from being applied to the flat cable body 203, so that good signal transmission performance is maintained for a long period of time.

Further, the first flat cable part 201 of the flexible flat cable 200 has a higher electromagnetic shielding performance than the second flat cable part 202. Accordingly, in the first flat cable part 201, upon outputting an image signal to the control board 91, the effect of electromagnetic radiation on the control board 91 that performs various types of signal processing such as image processing is suppressed due to the higher electromagnetic shielding performance than that of the second flat cable part 202.

In the flexible flat cable 200, the first flat cable part 201 and the second flat cable part 202 that have the different electromagnetic shielding structures each including an electromagnetic body are different in the proportion of the electromagnetic shielding structure to the entire length of the flexible flat cable 200 such that the resonance attenuation frequency band with respect to the frequency of the signal transmitted to the flexible flat cable 200 is set to about 4 GHz or higher.

### Experiment

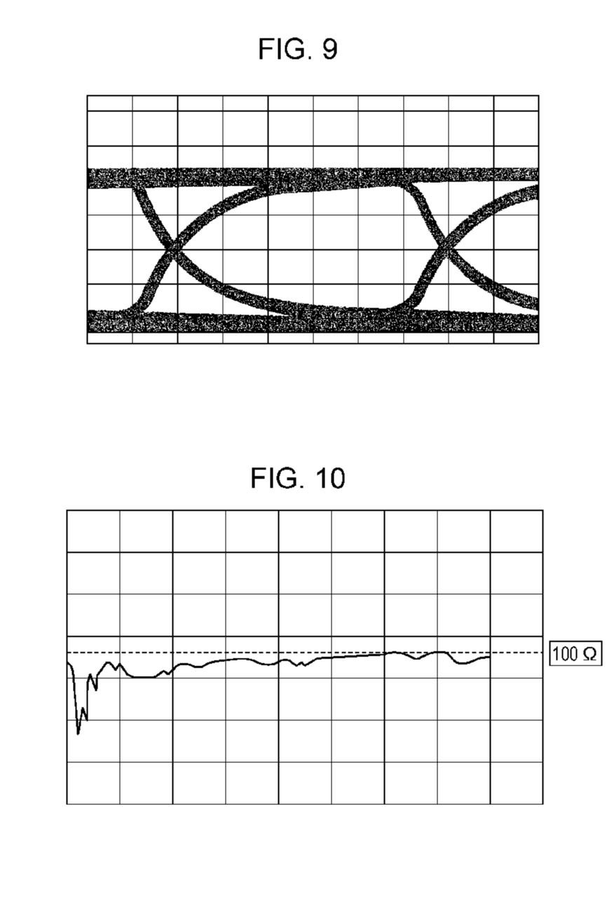

FIGS. 9 through 11B illustrate the high-frequency transmission characteristics of the flexible flat cable 200 of the first exemplary embodiment.

FIG. 9 illustrates an eye pattern in which a number of transitions of high-frequency signal waveforms transmitted through the flexible flat cable 200 are sampled and superimposed on one another. As is clear from FIG. 9, plural signal waveforms are superimposed at the same position (timing, voltage), so that good transmission characteristics are obtained in which jitter representing fluctuations in the waveform in the time axis and the disturbance in an image due to the fluctuations are suppressed.

FIG. 10 is a graph representing the characteristic impedance of the flexible flat cable 200.

As is clear from FIG. 10, as for a characteristic impedance of 100Ω required by the flexible flat cable 200, the flexible flat cable 200 of the first exemplary embodiment substantially satisfies the requirement.

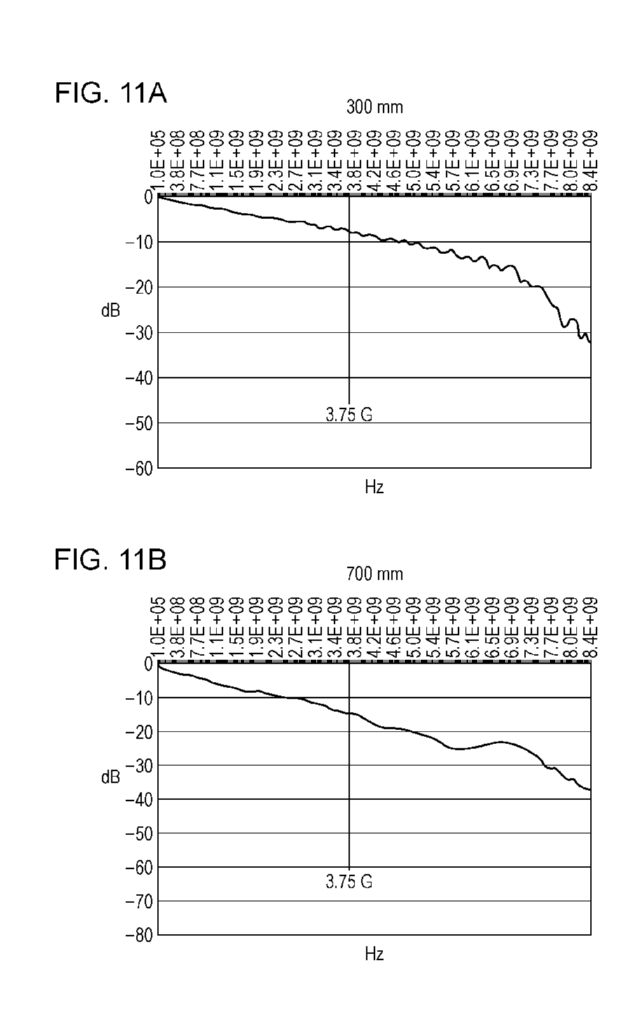

FIGS. 11A and 11B are graphs each illustrating the frequency characteristic of the insertion loss of the flexible flat cable 200. FIG. 11A illustrates the case where the entire length of the flexible flat cable 200 is 300 mm, and FIG. 11B illustrates the case where the flexible flat cable 200 is 700 mm.

As is clear from FIGS. 11A and 11B, in the case of the flexible flat cable 200 according to the first exemplary embodiment, the resonance attenuation frequency band is as high as about 4 GHz or higher, so that good transmission characteristics are obtained at a transmission rate of 3.75 Gbps.

On the other hand, the inventor confirmed that in the case where the electromagnetic shielding structure of a flexible flat cable is made of a single material, resonance attenuation occurs in the natural frequency band of an electromagnetic shielding material serving as a dielectric body.

### Second Exemplary Embodiment

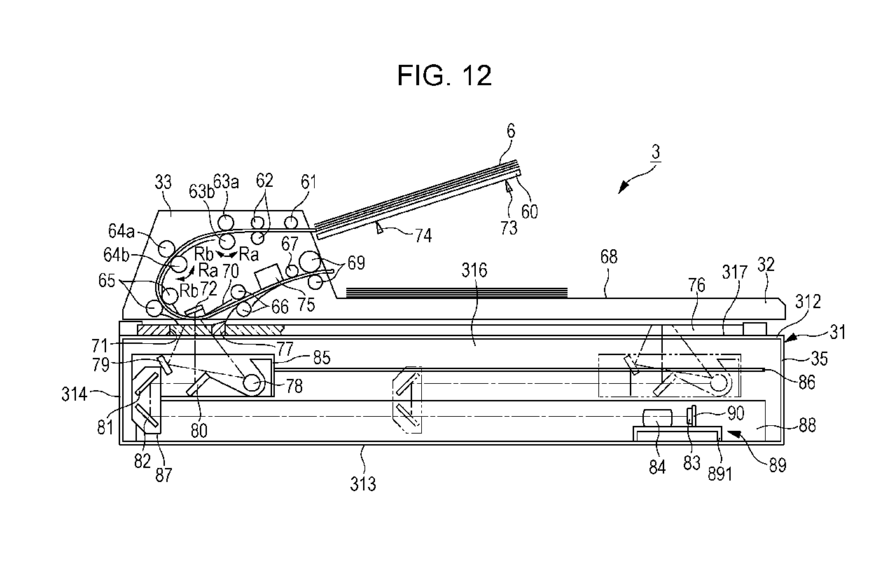

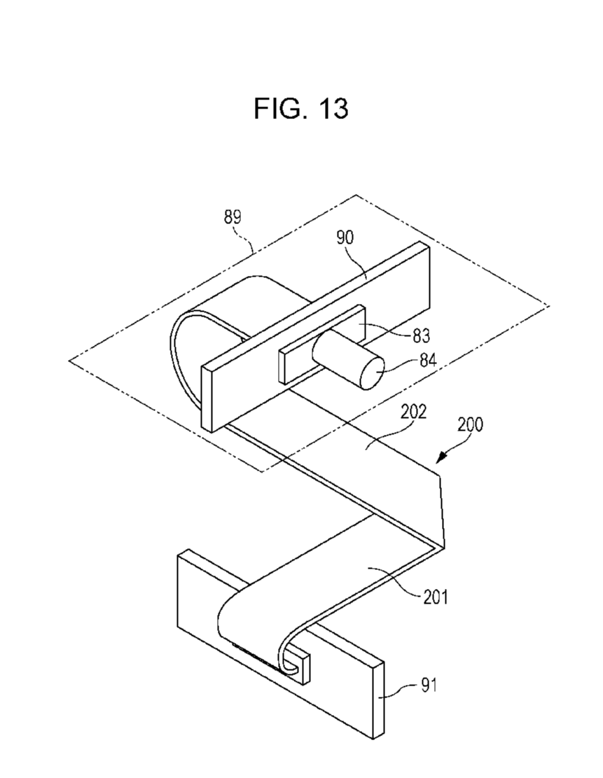

FIGS. 12 and 13 illustrate the configuration of an image reading apparatus 3 and a flexible flat cable 200, respectively, according to a second exemplary embodiment of the invention.

Configuration of Image Reading Apparatus

As illustrated in FIGS. 12 and 13, the image reading apparatus 3 includes, in a housing 31, a light source 78 including a light emitting diode (LED) and an illuminating lamp that illuminates a document 6, a reflector 79 as a reflection member that reflects a part of the light emitted from the light source 78 toward the document 6, a first mirror 80 that receives light reflected from the document 6, a second mirror 81 that receives light reflected from the first mirror 80, a third mirror 82 that receives light reflected from the second mirror 81, and an image reading section 89. The image reading section 89 includes an imaging lens 84 that forms an image of the light reflected from the third mirror 82 on an image forming element 83 including a Charge Coupled Device (CCD). The light source 78, the reflector 79, and the first through third mirrors 80 through 82 are disposed in a main scanning direction (the direction orthogonal to the plane of FIG. 12). Further, the light source 78 emits light toward a specular reflection board 72 and the reflector 79.

The light source 78, the reflector 79, and the first mirror 80 are disposed in the main scanning direction, and are fixed to a first moving body 85 that includes a carriage and that is movable in a sub scanning direction. While the first moving body 85 moves in the sub scanning direction by being guided by first rails 86 disposed on a rear wall 316 of the housing 31 in the sub scanning direction, an area of the document 6 to be read is illuminated, and the light reflected from the document 6 is reflected by the first mirror 80 toward the second mirror 81 of the second moving body 87.

The second mirror 81 and the third mirror 82 are disposed in the main scanning direction, and are fixed to a second moving body 87 that includes a carriage and that is movable in the sub scanning direction. While the second moving body 87 moves in the sub scanning direction by being guided by second rails 88 disposed on a bottom wall 313 of the housing 31 in the sub scanning direction, the light reflected from the document 6 is reflected toward the imaging lens 84 of the image reading section 89. The first rails 86 and the second rails 88 are respectively provided one on each end in the main scanning direction so as to face each other.

The image reading section 89 includes a first circuit board 90 with the imaging lens 84 and the image reading element 83 mounted thereon. The first circuit board 90 is fixed to a base plate 891 supported on the bottom wall 313. The image reading section 89 forms an image of the light reflected from the third mirror 82 and transmitted through the imaging lens 84, on the image reading element 83 including a CCD. Thus, the image reading section 89 reads the image of the document 6 using the image reading element 83, and outputs image data.

In the second reading mode, the first moving body 85 and the second moving body 87 are driven by a driving mechanism (not illustrated). The amount of movement of the second moving body 87 is half the amount of movement of the first moving body 85 such that an optical path length from an image reading portion of the document 6 to the image reading element 83 (described below) does not change while the first moving body 85 moves in the sub scanning direction. In FIG. 12, the two-dot chain lines indicate the positions of the first moving body 85 and the second moving body 87 at the time when the first moving body 85 is moved near an end of the document 6 in the sub scanning direction.

Configuration of Part of Image Reading Apparatus

As illustrated in FIG. 13, the image reading apparatus 3 according to the second exemplary embodiment includes the flexible flat cable 200 which connects the first circuit board 90 with the image reading element 83 mounted thereon and a control board 91 to each other.

The flexible flat cable 200 includes a first flat cable part 201 disposed at the control board 91 side and a second flat cable part 202 disposed at the first circuit board 90 side.

In the second exemplary embodiment, the flexible flat cable 200 has bent portions at the joints to the control board 91 and the first circuit board 90. However, since the first circuit board 90 with the image reading element 83 mounted thereon is fixed to the housing 31 of the image reading apparatus 3, a sliding portion is not provided unlike the first exemplary embodiment.

Since the flexible flat cable 200 according to the second exemplary embodiment includes the first flat cable part 201 and the second flat cable part 202, the degree of freedom in designing the image reading apparatus 3 may be increased by appropriately determining the configuration of a shield layer 204 of the first flat cable part 201 and a shield layer 207 of the second flat cable part 202.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A flexible flat cable comprising:
a first flat cable part having an electromagnetic shielding structure and flexibility; and
a second flat cable part having an electromagnetic shielding structure and flexibility,
wherein the first flat cable part includes a first shield layer that covers an entire periphery including front and back surfaces and opposite side surfaces of a flat cable body, and
wherein the second flat cable part includes a second shield layer that covers either one of the front surface and the back surface of the flat cable body.

2. The flexible flat cable according to claim 1, wherein the first flat cable part has a higher electromagnetic shielding performance than the second flat cable part.

3. The flexible flat cable according to claim 1, wherein the second flat cable part has a higher flexibility than the first flat cable part.

4. The flexible flat cable according to claim 1, wherein the first flat cable part has the electromagnetic shielding structure extending around an entire periphery of the first flat cable part.

5. The flexible flat cable according to claim 1, wherein the second flat cable part has the electromagnetic shielding structure extending only on either surface of the second flat cable part.

6. The flexible flat cable according to claim 1, wherein the first flat cable part and the second flat cable part have different electromagnetic shielding structures each including an electromagnetic body, and are different in proportion of the electromagnetic shielding structure to an entire length of the flexible flat cable such that a resonance attenuation frequency band with respect to a frequency of a signal transmitted to the flexible flat cable is set to about 4 GHz or higher.

7. An image reading apparatus comprising:
a first circuit board on which an image reading element configured to read an image is mounted;
a second circuit board configured to process an image signal output from the first circuit board; and
a flexible flat cable that connects the first circuit board and the second circuit board to each other;
wherein the flexible flat cable is the flexible flat cable of claim 1.

8. An image forming apparatus comprising:
an image reading unit configured to read an image of a document; and
an image forming unit configured to form the image of the document read by the image reading unit;
the image reading unit is the image reading apparatus of claim 7.

9. The flexible flat cable according to claim 1, wherein the second shield layer covers only one of the front surface and the back surface of the flat cable body.

10. The flexible flat cable according to claim 9, wherein the second shield layer does not cover the opposite side surfaces of the flat cable body.
